(19) United States
(12) Patent Application Publication
(10) Pub. No.: US 2025/0325859 A1
(43) Pub. Date: Oct. 23, 2025

(54) Live Fire Training System and Method Including a Modular Live Fire Burn Room for Training Firefighters

(71) Applicant: D.R. Reynolds Company, Inc., Star, NC (US)

(72) Inventor: Danny Ray Reynolds, Star, NC (US)

(73) Assignee: D.R. Reynolds Company, Inc., Star, NC (US)

(21) Appl. No.: 18/989,157

(22) Filed: Dec. 20, 2024

Related U.S. Application Data
(60) Provisional application No. 63/634,997, filed on Apr. 17, 2024.

(51) Int. Cl. A62C 99/00

(52) U.S. Cl. CPC A62C 99/0081

(57) ABSTRACT

A modular fire training system. The modular fire training system may include an outer structure; an inner structure, the inner structure may be configured to be positionable within the outer structure; one or more openings formed in either or both of the outer structure and/or the inner structure; a burn crib configured to be positionable within the inner structure; and an insulation layer disposed about an exterior of the inner structure.

### RELATED APPLICATIONS

This application is related and claims priority to U.S. Provisional Patent Application No.: 63/634,997, filed on Apr. 17, 2024 the application of which is incorporate herein by reference in its entirety.

### TECHNICAL FIELD

The subject matter of the invention relates generally to a live fire training room and system, and more particularly to a live fire training system and method including a modular live fire burn room for training firefighters.

### BACKGROUND

Live firefighter training typically involves the use of live fire burn rooms designed for the purpose of training firefighters. Some live fire burn rooms are made from standard Conex type shipping container, and the inside surfaces of the walls and ceiling are lined with special insulating tiles or panels to protect the walls and ceiling from damage that would otherwise result from the heat generated inside of the burn room by the live training fire. A drawback of these existing types of live fire rooms is that, if damaged, it can be difficult and expensive to repair and/or replace the special insulating tiles or panels. Accordingly, what is needed is an improved live fire burn room that is easier and/or less expensive to repair and/or replace.

### SUMMARY

In one embodiment, a modular fire training system is provided. The modular fire training system may include an outer structure; an inner structure, the inner structure may be configured to be positionable within the outer structure; one or more openings formed in either or both of the outer structure and/or the inner structure; a burn crib configured to be positionable within the inner structure; and an insulation layer disposed about an exterior of the inner structure. The one or more openings may include any one or more of doors, windows, and/or cleanouts. The inner structure may include a burn box, wherein the burn box may include an arrangement of panels, the arrangement of panels configured to form a generally rectangular structure. The outer structure may include a shipping or storage container. The shipping or storage container may include any of a conex container, an ISO box, an ISO shipping container, or an ISO freight container. The system may further include a fuel source, wherein the burn crib may be configured to receive the fuel source. The insulation layer may include a high temperature insulation blanket. The system may further include an air gap formed between an outer surface of the insulation layer of one or more of the panels of the burn box and one or more associated interior surfaces of the outer structure when the burn box is positioned within the outer structure. The one or more of the panels of the burn box may include a first side panel, a second side panel, a back side panel, and a ceiling panel.

In another embodiment, a burn box is provided. The burn box may include an arrangement of panels configured to form a generally rectangular structure; and an insulation blanket disposed on an exterior surface thereof, wherein the arrangement of panels may include a plurality of side walls, a ceiling panel, and a floor panel. The arrangement of panels may include an arrangement of vertical and horizontal frame members covered with steel plating. The plurality of side walls may include, a first side wall, a second side wall, and a back side wall. The plurality of side walls may further include a front side wall. The one or more of the plurality of side walls may include one or more openings formed therein. The one or more openings may include any one or more of doors, windows, and/or cleanout. The burn box may further include one or more lift points provided at one or more positions on any one or more of the ceiling panel and/or side walls. The front side wall may include a door. The burn box may further include an approach apron, wherein the front side wall is set inward a distance from a first end of the burn box, and wherein the approach apron extends out from the front side wall to be substantially even with the first end of the burn box.

In yet another embodiment, a method of using a modular fire training system is provided. The method may include providing a modular fire training system. The modular fire training system may include an outer structure; an inner structure, the inner structure may be configured to be positionable within the outer structure; one or more openings formed in either or both of the outer structure and/or the inner structure; a burn crib configured to be positionable within the inner structure; and an insulation layer disposed about an exterior of the inner structure an outer structure. The method may further include positioning the inner structure within the outer structure and positioning the burn crib within the inner structure; adding a fuel source to the burn crib; igniting the fuel source and allowing a certain temperature and/or smoke level to be reached within the inner structure; and conducting a fire training exercise. The inner structure may include a burn box, and wherein the one or more openings may include any one or more of doors, windows, and/or cleanout. The method may further include allowing the burn box to cool and smoke to dissipate and cleaning out the burn box through the cleanout.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a live fire training system including a modular live fire burn room for training firefighters, in accordance with an embodiment of the invention;

FIG. 2 illustrates a perspective view of an example instantiation of the live fire training system shown in FIG. 1 and including a burn box having a flush-mounted front wall and front access door, in accordance with an embodiment of the invention;

FIG. 3 illustrates a perspective view of the live fire training system shown in FIG. 2 and wherein the burn box thereof is absent the front wall and front access door, in accordance with an embodiment of the invention;

FIG. 4 illustrates a front perspective view of an example of the burn box of the live fire training system shown in FIG. 3 that is absent the front wall and front access door, in accordance with an embodiment of the invention;

FIG. 5 illustrates a perspective view of another example instantiation of the live fire training system shown in FIG. 1 and including a burn box having an approach apron, in accordance with an embodiment of the invention;

FIG. 6 through FIG. 10 illustrate various perspective views of an example of the burn box of the live fire training system shown in FIG. 5 that has the approach apron, in accordance with an embodiment of the invention;

FIG. 11 through FIG. 15 illustrate various perspective views of an example of a burn box frame of any of the live fire training systems shown in FIG. 1 through FIG. 10, in accordance with an embodiment of the invention;

FIG. 16 through FIG. 19 illustrate detail drawings of a non-limiting example of the burn box frame shown in FIG. 11 through FIG. 15, in accordance with an embodiment of the invention;

FIG. 20 shows a burn box table indicating non-limiting example details of the burn box frame members shown in FIG. 16 through FIG. 19, in accordance with an embodiment of the invention;

FIG. 21 illustrates an example of plate flashing around an opening in the burn box, in accordance with an embodiment of the invention; and

FIG. 22 illustrates a flow diagram of an example of a method of using the live fire training system for training firefighters, in accordance with an embodiment of the invention.

### DETAILED DESCRIPTION

The subject matter of the invention now will be described more fully hereinafter with reference to the accompanying drawings, in which some, but not all embodiments of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention may provide a live fire training system and method including a modular live fire burn room.

In some embodiments, the live fire training system and method may provide an inner structure, such as, but not limited to, a fire burn room or fire burn box, installed in an outer structure, such as, but not limited to, a Conex shipping or storage container.

In some embodiments, the live fire training system and method may provide a fire-rated inner structure installed in a large metal outer structure.

In some embodiments, the live fire training system and method may provide a fire-rated inner structure installed in a large metal outer structure and wherein the fire-rated inner structure may be, for example, a high temperature burn box rated at about 2,100 degrees Fahrenheit (F).

In some embodiments, the live fire training system and method may provide a fire-rated inner structure installed in a large metal outer structure and wherein the large metal outer structure may be, for example, a Conex shipping or storage container.

In some embodiments, the live fire training system and method may provide a fuel source capable of producing live fire (or flame) and/or smoke within the fire-rated inner structure.

In some embodiments, the live fire training system and method may provide a fire-rated inner structure, a large metal outer structure, and a fuel source wherein together the fire-rated inner structure, the large metal outer structure, and the fuel source support a modular live fire burn room configuration.

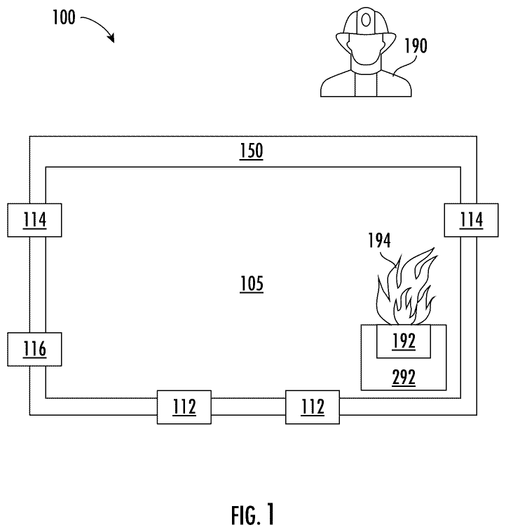

Referring now to FIG. 1 is a block diagram of an example of a live fire training system 100 including a modular live fire burn room for training firefighters 190, in accordance with an embodiment of the invention.

Live fire training system 100 may include an inner structure 105 installed in an outer structure 150. Further, inner structure 105 and outer structure 150 of live fire training system 100 may include any arrangements of one or more access doors 112 and one or more access windows 114. Further, inner structure 105 and outer structure 150 may include any other openings 116 that may be useful in live fire training system 100.

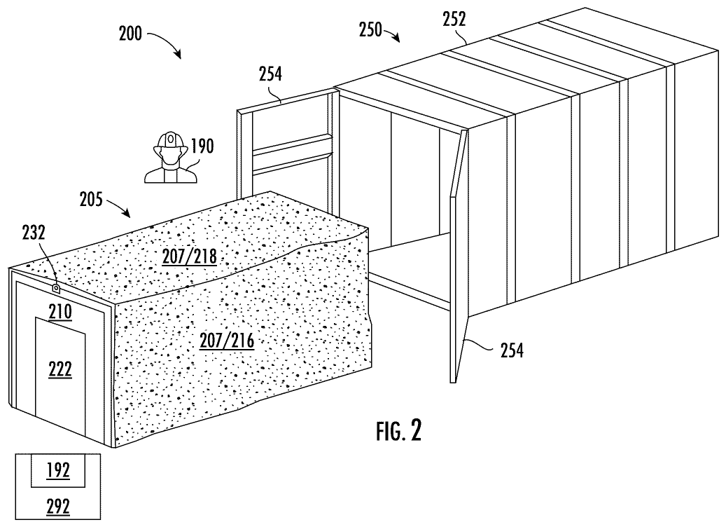

Inner structure 105 may be, for example, a high temperature rated fire burn room or fire burn box of live fire training system 100. For example, inner structure 105 may be a high temperature burn box rated for, in one non-limiting example, about 1,200 degrees F. More details of examples of inner structure 105 are shown and described below in FIG. 2 through FIG. 10.

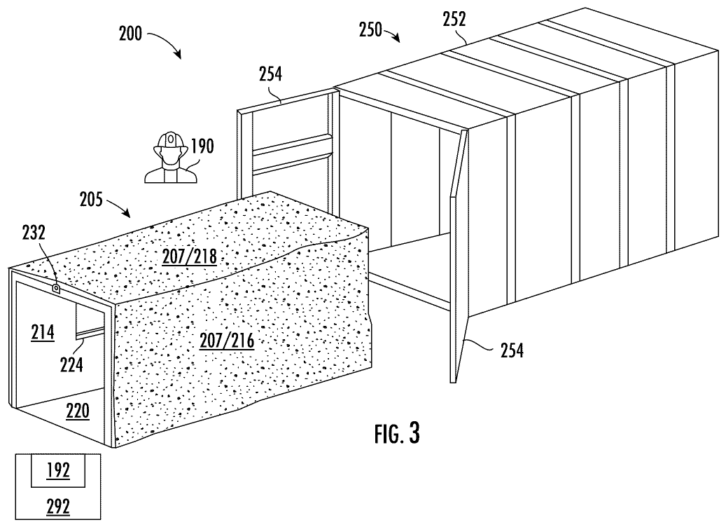

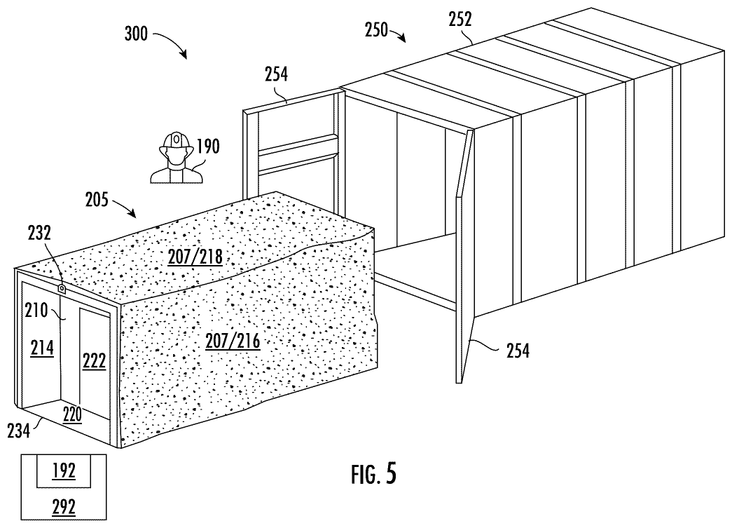

Outer structure 150 may be, for example, any large metal, weather-resistant container used to store or ship things and capable of carrying up to several thousand pounds (e.g., up to about 64,000 lbs.) depending on the size. For example, outer structure 150 may be a Conex shipping or storage container. Also known as an international organization for standardization (ISO) box, an ISO shipping container, or an ISO freight container. More details of examples of outer structure 150 are shown and described below in FIG. 2, FIG. 3, and FIG. 5.

Additionally, live fire training system 100 may include a fuel source 192 for fueling a live fire (or flame) 194. Fuel source 192 may be any fuel source capable of producing live fire (or flame) 194 and/or smoke within inner structure 105 and wherein the live fire (or flame) 194 and/or smoke may be extinguishable by conventional firefighting means. In one example, fuel source 192 may consist of wood, straw, and/or any other suitable material. In one example, multi-use burn crib 292 may be filled with fuel source 192 and positioned within inner structure 105 and ignited. Multi-use burn crib 292 may be any standard type burn crib capable of holding fuel source 192. In one example multi-use burn crib 292 may be a wheeled cart.

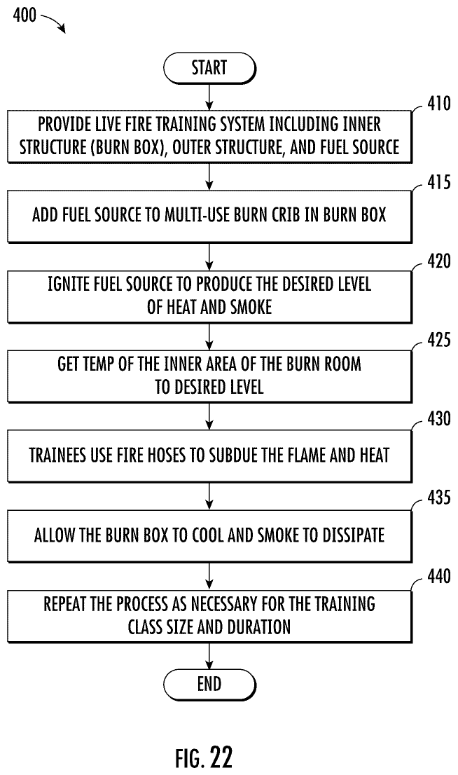

Together, inner structure 105, outer structure 150, and fuel source 192 of live fire training system 100 support a modular live fire burn room configuration. More details of examples of live fire training system 100 are shown below in FIG. 2, FIG. 3, and FIG. 5. Further, a method of using live fire training system 100 is shown and described below in FIG. 22.

Referring now to FIG. 2 is a perspective view of a live fire training system 200, which is an example instantiation of the live fire training system 100 shown in FIG. 1. In live fire training system 200, a burn box 205 may have a flush-mounted front wall and front access door, in accordance with an example embodiment of the invention.

More specifically, live fire training system 200 may include the burn box 205 that is designed to be fitted within a shipping container 250. In live fire training system 200, burn box 205 may be an example of inner structure 105 of live fire training system 100 shown in FIG. 1. Likewise, shipping container 250 may be an example of outer structure 150 of live fire training system 100.

Burn box 205 may be formed via an arrangement of panels enclosed in blanket insulation 207. In one non-limiting example, blanket insulation 207 may be 2-inch ceramic, high temperature (e.g., 2,100 degrees F.-rated), blanket insulation. Blanket insulation 207 may be made of any other suitable material that provides the desired level insulating properties.

FIG. 2 shows that burn box 205 may include a front wall 210 that may have a front access door 222. Front access door 222 may be one example of access doors 112 of live fire training system 100 shown in FIG. 1. Front wall 210 with front access door 222 may be considered flush-mounted because they are installed at one extreme end of burn box 205.

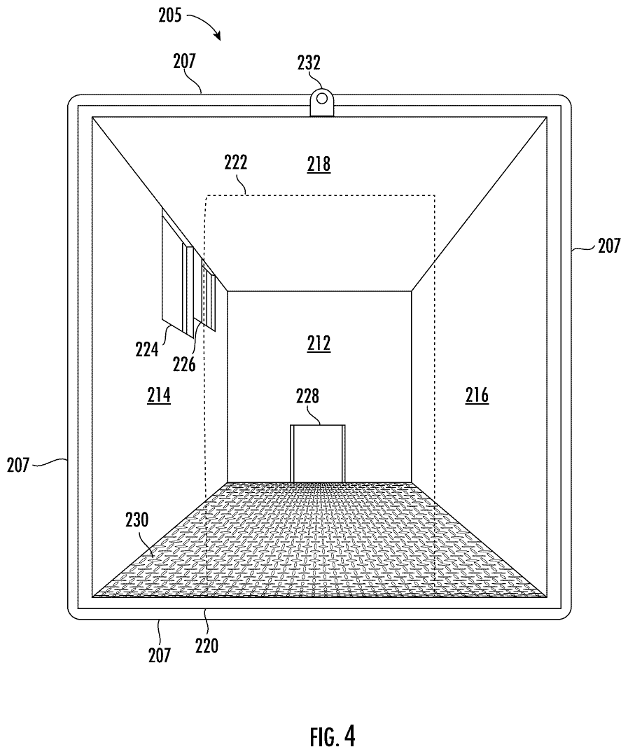

Referring now to FIG. 3, burn box 205 is shown absent the front wall 210 and front access door 222. Further to the example, FIG. 4 shows a front perspective view of an example of burn box 205 absent the front wall 210 and front access door 222 and revealing other components thereof.

Referring now to FIG. 2, FIG. 3, and FIG. 4, burn box 205 may also include a back wall 212, a first side wall 214, a second side wall 216, a ceiling panel 218, and a floor panel 220. Additionally, side wall 214 may include a training window 224 and/or a vent window 226. Additionally, back wall 212 may include a cleanout 228. Further, a tread plate 230 (see FIG. 4) may be provided atop floor panel 220. Further, a lift point 232 may be provided at the end of ceiling panel 218 nearest front wall 210 and/or at the end of ceiling panel 218 nearest back wall 212. Training window 224 and/or vent window 226 may be examples of access windows 114 of live fire training system 100 shown in FIG. 1. Cleanout 228 may be an example of other openings 116 of live fire training system 100 shown in FIG. 1.

Burn box 205 may be constructed to safely perform controlled burns preferably in the range of about 1,200 degrees F. For example, front wall 210, back wall 212, first side wall 214, second side wall 216, ceiling panel 218, and floor panel 220 may be enclosed using high temperature blanket insulation 207 (e.g., 2,100 degrees F.-rated), and may further include 0.25-inch mild steel cover. Further, a coat of high temperature paint may be applied to the inside surface of the steel cover panels to assist in the prevention of rust build up on the material.

Front access door 222 may be an exterior access door. Front access door 222 may be, for example, a heavy hinged insulated burn door, and may include a frame made of frame members 242, e.g., like those that make up burn box frame 240, and may further be insulated with 0.25 inch plate steel on both sides of the front access door 222. Front access door 222 may further include hinged and pinned slots (e.g., about 7-inch X about 7-inch) to allow safe hose passage when closed. In other examples, burn box 205 may include one or more interior standard access doors (not shown), which may, for example, be similar to front access door 222. Training window 224 may be a standard window fabricated with standard latch hardware. A pull handle may be included at each window. Vent window 226 may include a heavy-duty winch and cable operating system (not shown). In one example, vent window 224, vent 226, and/or clean out(s) 228 are all double sided and insulated. In one example, burn box 205 may be about 7 ft wide, about 7 ft high, and about 18 ft long.

Referring still to FIG. 2, FIG. 3, and FIG. 4, shipping container 250 may include a container portion 252, which may include doors 254 at one end. Shipping container 250 may be, for example, a Conex shipping or storage container. Shipping container 250 may be sized to receive burn box 205 therein. In one non-limiting example, shipping container 250 may be about 8 feet wide, about 9 feet 6 inches high, and about 40 feet long.

Referring now to FIG. 5 is a perspective view of a live fire training system 300, which is another example instantiation of the live fire training system 100 shown in FIG. 1. In live fire training system 300, a burn box 305 may include an approach apron 234, in accordance with an example embodiment of the invention.

Along with burn box 305, live fire training system 300 may include the shipping container 250 that is described in FIG. 2. Burn box 305 may be substantially the same as burn box 205 described in FIG. 2, FIG. 3, and FIG. 4 except for the inclusion of the approach apron 234. In one non-limiting example, approach apron 234 may be about 4-foot. That is, front wall 210 and front access door 222 may be located inward, e.g., about 4 feet, from one end of burn box 305.

Referring to FIG. 1, FIG. 2, FIG. 3, FIG. 4, FIG. 5, and FIG. 22, burn box 205/305, in one example, burn box 205/305 may be positioned within shipping container 250 such that there is about a 1.5 inch air gap between the outer surface of the blanket insulation 207 that covers the back wall 212, first side wall 214, and second side wall 216, and the interior surface of the end and side walls of the shipping container 250. Further, burn box 205/305 may be positioned within shipping container 250 such that there is about a 7 inch air gap between the outer surface of the blanket insulation 207 that covers the ceiling panel 218 and the interior surface of the ceiling of the shipping container 250.

Still referring to FIG. 1, FIG. 2, FIG. 3, FIG. 4, FIG. 5, and FIG. 22, burn box 205/305 may be positioned within shipping container 250, and openings 114/116, such as training window(s) 224, vent window(s) 226, and/or clean out(s) 228 of the burn box 205/305 may be installed/formed in the shipping container by, for example, removing exterior portions of the shipping container 250 skin that align with the training window(s) 224, vent window(s) 226, and/or clean out(s) 228 of the burn box 205/305, and adding, for example, plate flashing 256 (as shown for example in FIG. 22). The plate flashing 256 may be ¼ or 3/16 inch steel, and may be form broke or other forming technique, to flash around openings 114/116. The plate flashing helps to contain and keep a thermal barrier and protect the exterior and interior of shipping container 250.

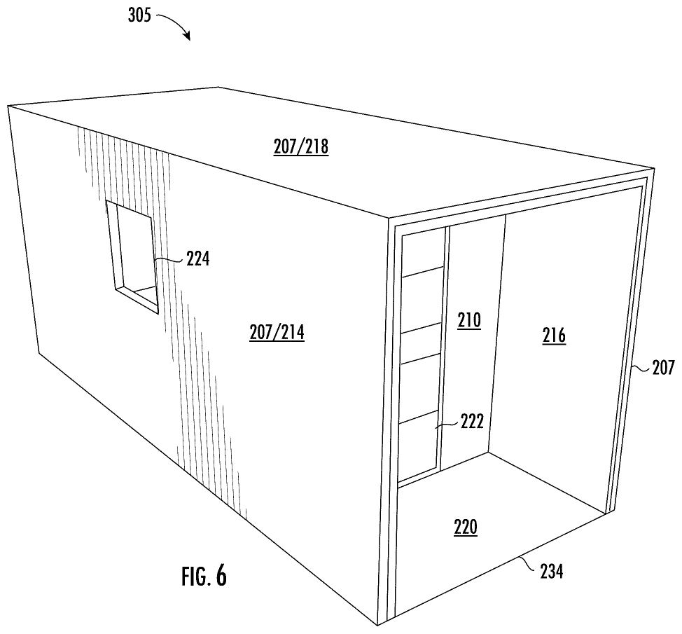

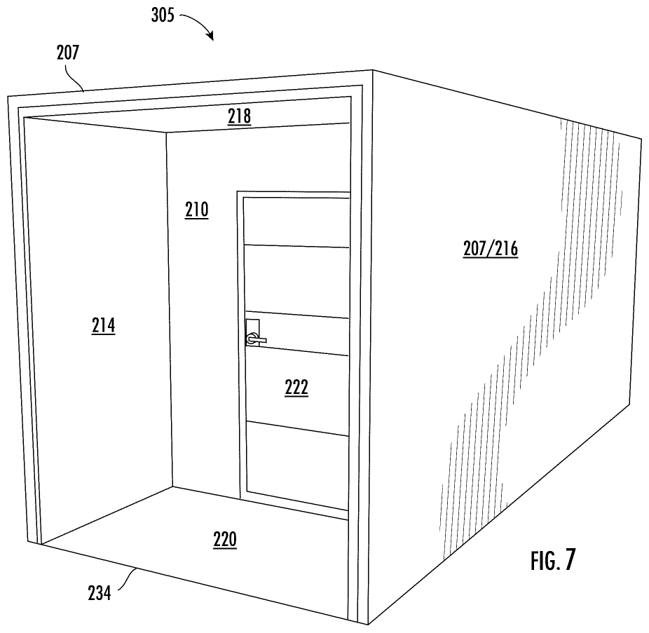

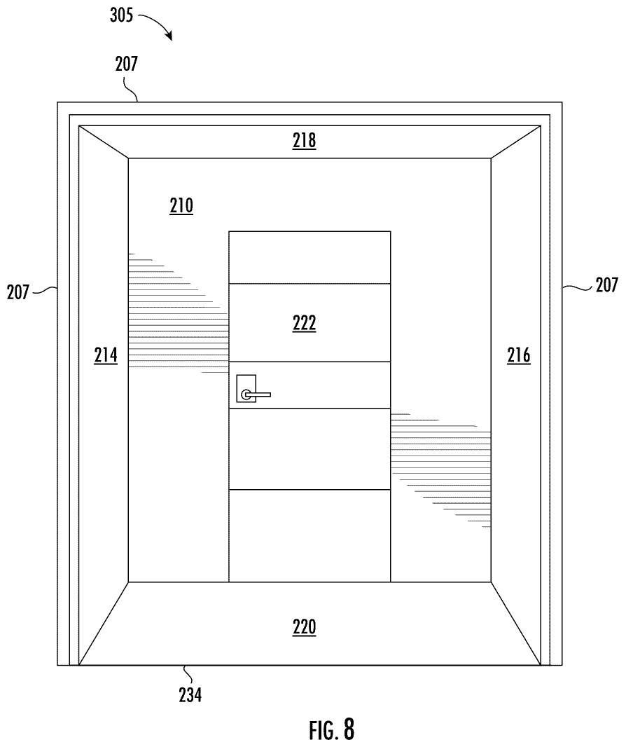

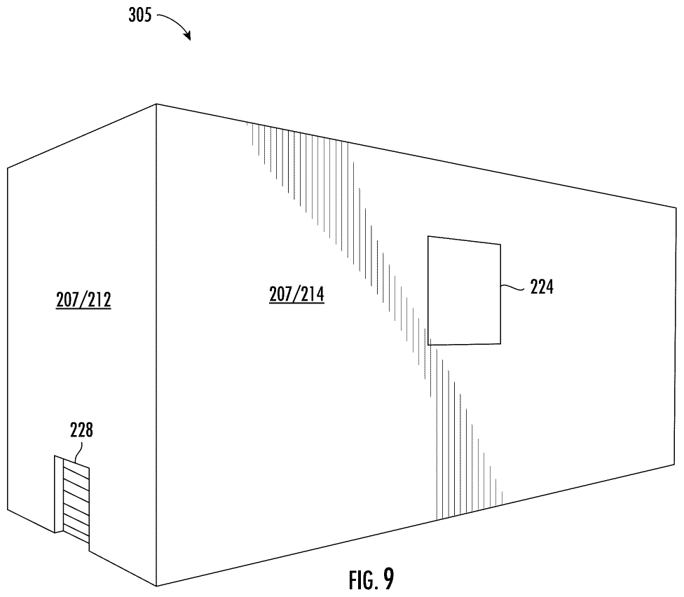

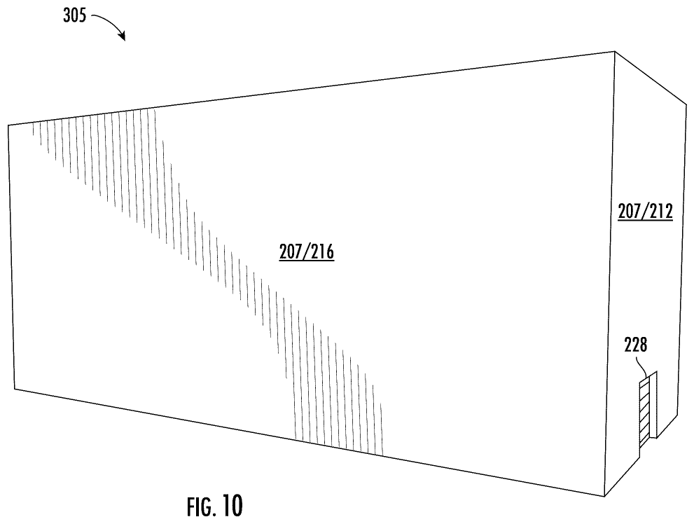

Referring now to FIG. 6 through FIG. 10 is various perspective views of an example of burn box 305 of live fire training system 300 shown in FIG. 5 that has the approach apron 234, in accordance with an embodiment of the invention. In this example, burn box 305 may be absent the vent window 226. FIG. 6, FIG. 7, and FIG. 8 show three different front perspective views of burn box 305. FIG. 9 and FIG. 10 show two different back perspective views of burn box 305.

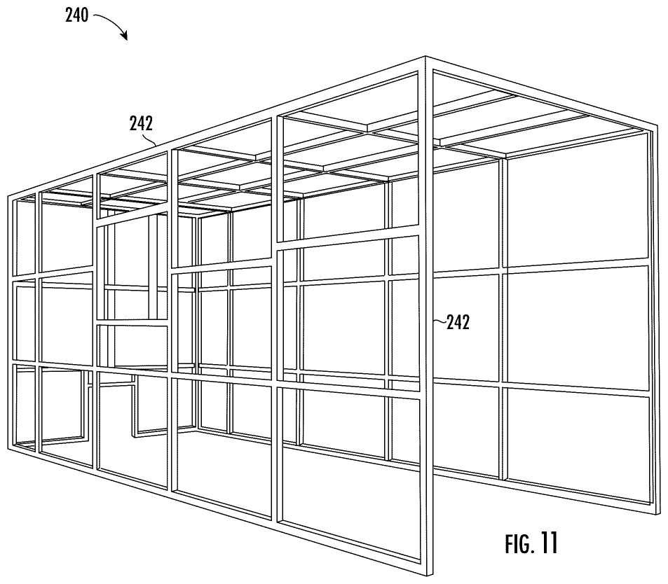

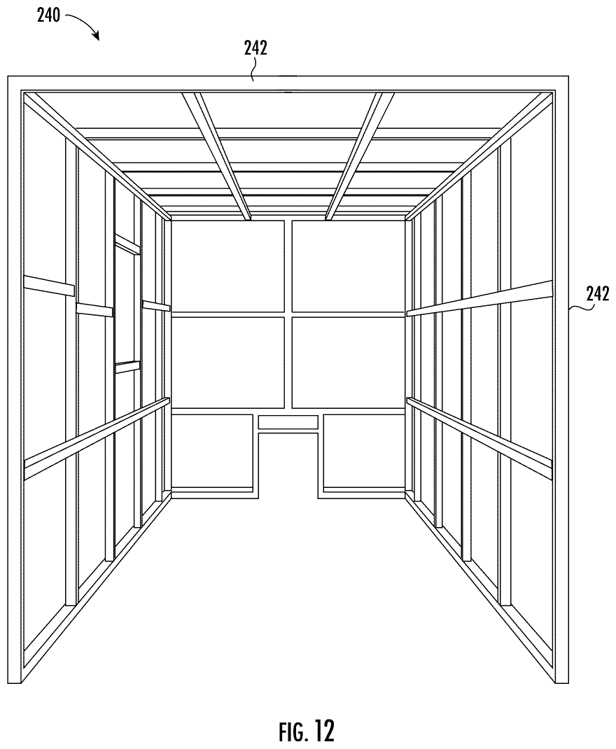

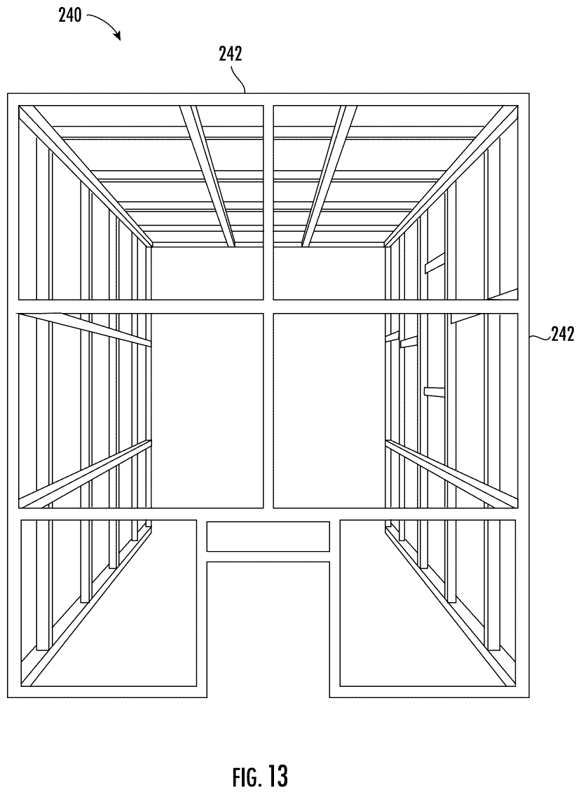

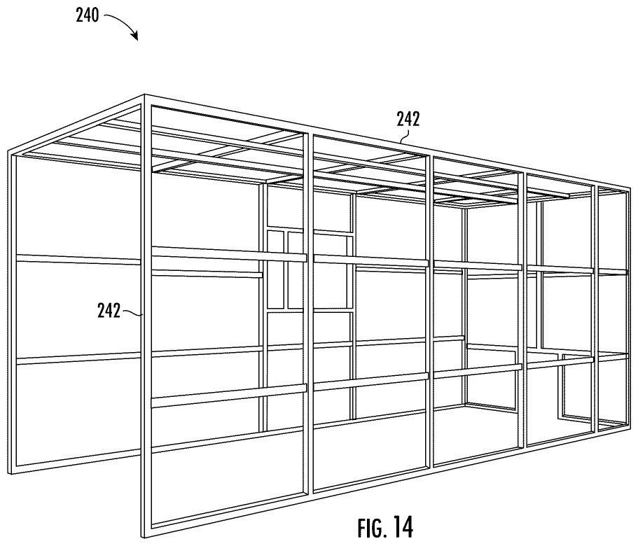

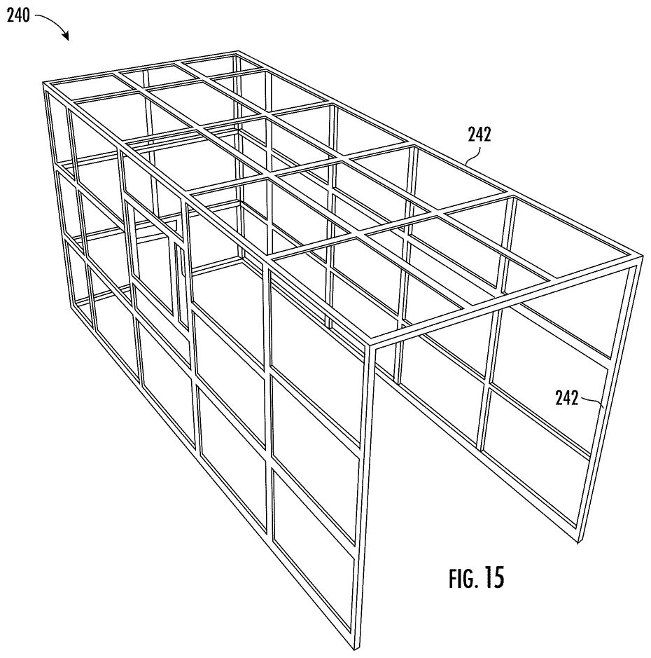

Referring now to FIG. 11 through FIG. 15 is various perspective views of an example of a burn box frame 240 of any of the live fire training systems 100, 200, 300 shown in FIG. 1 through FIG. 10, in accordance with an embodiment of the invention. Burn box frame 240 may include an arrangement of vertical and horizontal frame members 242, as shown in FIG. 11 through FIG. 15.

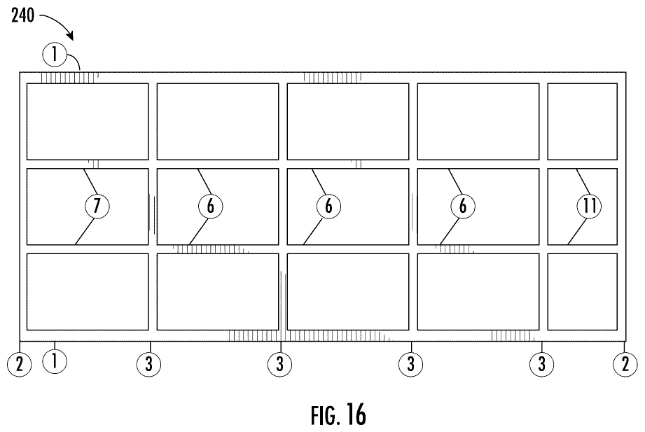

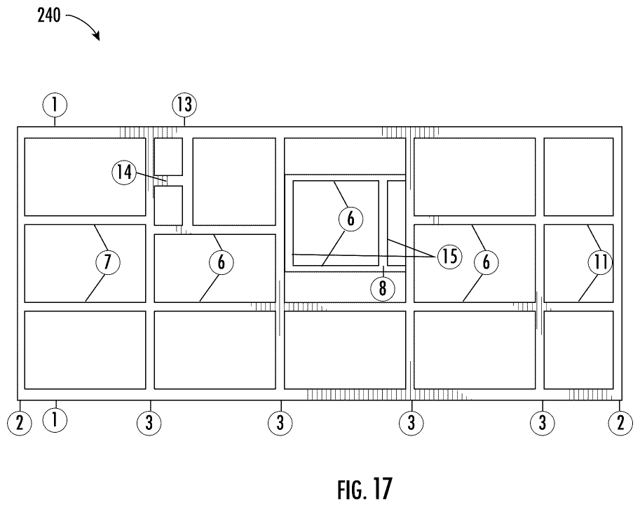

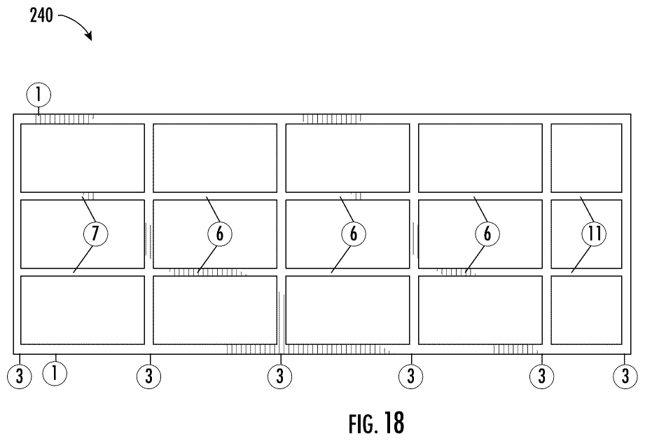

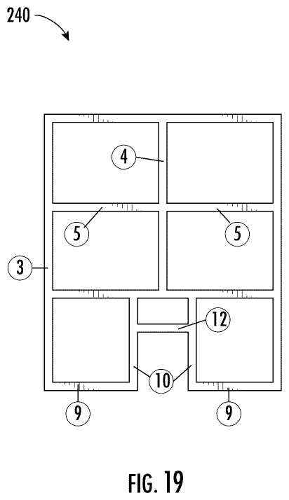

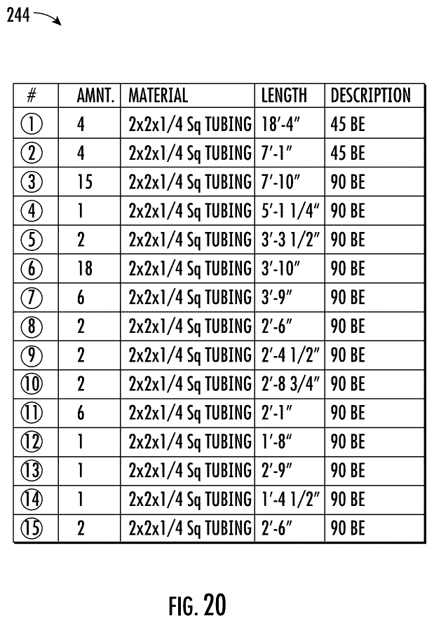

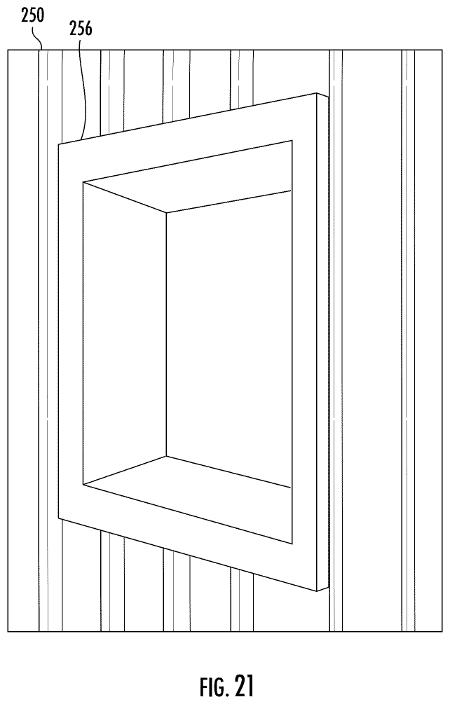

Referring now to FIG. 16 through FIG. 19 is detail drawings of an example of the burn box frame 240 shown in FIG. 11 through FIG. 15, in accordance with an example embodiment of the invention. The detail drawings show frame members 242 labeled as tubing items 1 through 15. The tubing items 1 through 15 are described in a burn box table 244 shown in FIG. 21. The amounts, materials, lengths, and description information listed in the burn box table 244 is exemplary only.

In one example, multi-use burn crib 292 may be a cart that is fabricated to hold straw, pallets, and or other suitable material and that fits inside, for example, burn box 205, 305. In one example, multi-use burn crib 292 may be constructed of mild steel and may include metal casters for ease of locating the multi-use burn crib 292 within the burn box 205, 305. Multi-use burn crib 292 may further include a coat of high temp paint to, for example, prevent rust build up. Burn box 205, 305 may act as a barrier so that most of the heat from the fire stays in that room but the firemen are able to get the smoke effect throughout the remainder of the training unit.

In other embodiments, live fire training systems 100, 200, 300 may include multiple burn boxes 205 and shipping containers 250 positioned together to simulate multi-room/training scenarios that may single story and/or multi story structures. In some examples, burn box 205 and shipping container 250 may include vent props (not shown), which may be an opening/access in the ceiling, for additional training simulations, including for example, accessing the burn box 205 via the ceiling.

Referring now to FIG. 23 is a flow diagram of an example of a method 400 of using live fire training systems 100, 200, 300 for training firefighters, in accordance with an embodiment of the invention. Method 400 may include, but is not limited to, the following steps.

At a step 410, a live fire training system including the inner structure, the outer structure, and the fuel source is provided. In one example, live fire training system 100 including inner structure 105, outer structure 150, and fuel source 192 is provided, as shown in FIG. 1. In another example, live fire training system 200 including burn box 205, shipping container 250, and fuel source 192 is provided, as shown in FIG. 2. In yet another example, live fire training system 300 including burn box 305, shipping container 250, and fuel source 192 is provided, as shown in FIG. 5.

At a step 415, add fuel source to the multi-use burn crib inside of the burn room. In one example, a fuel source 192 may be added to a multi-use burn crib 292, and positioned inside a burn room 205/305.

At a step 420, ignite fuel source to produce the desired heat and smoke. In one example, fuel source 192 may be ignited using any suitable mechanism.

At a step 425, get temperature inside of the burn room to desired level of heat, e.g., in the range of about, but not exceeding 1,200 degrees Fahrenheit. In one example, the temperature inside of the burn room 205/305 is elevated to a desired level of heat, e.g., in the range of about 1,200 degrees Fahrenheit.

At a step 430, trainees use hoses and/or other fire extinguishing mechanisms and/or techniques to subdue the flame and heat. In one example, trainee firefighters 190 use firehoses and/or other firefighting equipment to access and subdue the flames and heat inside the burn room 205/305.

At a step 435, the burn box is allowed to cool and smoke to dissipate. In one example, the burn box 205/305 is allowed to cool and the smoke dissipates. Once cooled, the burn box 205/305 may be cleaned out as may be needed, and may be cleaned out via cleanout 228.

At a step 440, the process may be repeated as necessary, depending for example, on the training class size and/or duration.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments±100%, in some embodiments±50%, in some embodiments±20%, in some embodiments±10%, in some embodiments±5%, in some embodiments±1%, in some embodiments±0.5%, and in some embodiments±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A modular fire training system, comprising:
a. an outer structure;
b. an inner structure, the inner structure configured to be positionable within the outer structure;
c. one or more openings formed in either or both of the outer structure and/or the inner structure;
d. a burn crib configured to be positionable within the inner structure; and
e. an insulation layer disposed about an exterior of the inner structure.

2. The system of claim 1, wherein the one or more openings comprise any one or more of doors, windows, vents, and/or cleanouts.

3. The system of claim 1, wherein the one or more openings are formed in both of the outer structure and the inner structure, and wherein the one or more openings are configured such that in a configuration where the inner structure is positioned within the outer structure the one or more openings of the inner structure align with the one or more openings of the outer structure.

4. The system of claim 1, wherein the inner structure comprises a burn box comprising an arrangement of panels, the arrangement of panels configured to form a generally rectangular structure.

5. The system of claim 1, wherein the outer structure comprises a shipping or storage container.

6. The system of claim 1, wherein the shipping or storage container comprises any of a conex container, an ISO box, an ISO shipping container, or an ISO freight container.

7. The system of claim 1, further comprising a fuel source, wherein the burn crib is configured to receive the fuel source.

8. The system of claim 1, wherein the insulation layer comprises a high temperature insulation blanket.

9. The system of claim 4, further comprising an air gap formed between an outer surface of the insulation layer of one or more of the panels of the burn box and one or more associated interior surfaces of the outer structure when the burn box is positioned within the outer structure.

10. The system of claim 9, wherein the one or more of the panels of the burn box comprise a first side panel, a second side panel, a back side panel, and a ceiling panel.

11. A burn box, comprising an arrangement of panels configured to form a generally rectangular structure; and an insulation blanket disposed on an exterior surface thereof, wherein the arrangement of panels comprises a plurality of side walls, a ceiling panel, and a floor panel.

12. The burn box of claim 11, wherein the arrangement of panels comprises an arrangement of vertical and horizontal frame members covered with steel plating.

13. The burn box of claim 11, wherein the plurality of side walls comprises, a first side wall, a second side wall, and a back side wall.

14. The burn box of claim 13, wherein the plurality of side walls further comprises a front side wall.

15. The burn box of claim 11, wherein one or more of the plurality of side walls comprise one or more openings formed therein.

16. The burn box of claim 15, wherein the one or more openings comprise any one or more of doors, windows, vents, and/or cleanouts.

17. The burn box of claim 11, further comprising one or more lift points provided at one or more positions on any one or more of the ceiling panel and/or side walls.

18. The burn box of claim 14, wherein the front side wall comprises a door.

19. The burn box of claim 14, further comprising an approach apron, wherein the front side wall is set inward a distance from a first end of the burn box, and wherein the approach apron extends out from the front side wall to be substantially even with the first end of the burn box.

20. A method of using a fire training system, the method comprising:
a. providing a fire training system, comprising:
i. an outer structure;
ii. an inner structure, the inner structure configured to be positionable within the outer structure;
iii. one or more openings formed in either or both of the outer structure and/or the inner structure;
iv. a burn crib configured to be positionable within the inner structure; and
v. an insulation layer disposed about an exterior of the inner structure;
b. positioning the inner structure within the outer structure and positioning the burn crib within the inner structure;
c. adding a fuel source to the burn crib;
d. igniting the fuel source and allowing a certain temperature and/or smoke level to be reached within the inner structure; and
e. conducting a fire training exercise.

21. The method of claim 20, wherein the inner structure comprises a burn box, and wherein the one or more openings comprise any one or more of doors, windows, vents, and/or cleanouts.

22. The method of claim 21, further comprising allowing the burn box to cool and smoke to dissipate and cleaning out the burn box through the cleanout.
